(19) United States
(12) Patent Application Publication
(10) Pub. No.: US 2026/0309312 A1
(43) Pub. Date: Oct. 8, 2026

(54) OPERATING LAMP

(71) Applicant: F.A.R.O. FABBRICA APPARECCHIATURE RAZIONALI ODONTOIATRICHE S.P.A., Ornago (IT)

(72) Inventors: Antonio Tirinato, Cernusco sul Naviglio (IT); Emiliano Bacco, Bellusco (IT); Angelo Favonio, Vimercate (IT)

(21) Appl. No.: 19/482,400

(22) PCT Filed: May 8, 2024
(86) PCT No.: PCT/IB2024/054475

§ 371 Date: Nov. 7, 2025

(30) Foreign Application Priority Data
May 10, 2023 (IT) 102023000009342

(51) Int. Cl. F21V 17/02; F21V 7/06; F21V 14/04; F21V 29/76; F21W 131/202; F21W 131/205; F21Y 115/10

(52) U.S. Cl. CPC F21V 17/02; F21V 7/06; F21V 14/04; F21V 29/763; F21W 2131/202; F21W 2131/205; F21Y 2115/10

(57) ABSTRACT

An operating lamp is provided. The operating lamp comprises a lamp body, a luminous source mounted on the lamp body, a reflector, a plurality of mounting members spaced apart from each other and mounted on said lamp body, and a support body comprising a plurality of mounting portions. The reflector reflects a light beam emitted by said luminous source and focuses said beam along a luminous axis. Each mounting member has an end stop shoulder having an independently adjustable position relative to said lamp body along an adjustment axis of said mounting member. Each mounting portion can be slidably coupled to a mounting member along the adjustment axis. The end stop shoulder can limit the mounting portion from sliding along the adjustment axis. Each mounting portion is pressed against the end stop shoulder by an elastic element. The reflector is mounted on the support body.

### CROSS-REFERENCE TO RELATED APPLICATION DATA

This application is a U.S. National Stage Application of International Application No. PCT/IB2024/054475, filed May 8, 2024, which claims the benefit of and priority to Italian Patent Application No. 102023000009342, filed May 10, 2023, the disclosure of each is incorporated herein by reference in its entirety.

### FIELD

The present invention refers to an operating lamp.

### BACKGROUND

Some technical sectors have the peculiarity of providing that the specialized operator performs their activity focusing their attention and their intervention in a predetermined operating field, the latter being understood as the physical sector or space in which the operator operates.

An example of technical sectors of this nature is dentistry, in which the operating field substantially coincides with the patient's mouth.

Another example of this type of technical sector is surgery, in which the surgeon operates in an operating field (also in this case strongly illuminated) in which the patient lies.

Further examples are represented by veterinary medicine, which has illumination needs of a type similar to surgery, and goldsmithing, where the goldsmith operates with his/her tools in a strongly lit operating field to enable the perfect illumination of the piece that he/she making.

By operating lamp is meant a lamp used to illuminate the operating field with a strongly directional light beam focused on a delimited illumination area.

Direct illumination of the environment surrounding the illumination area by the operating lamp is limited, for example in order to avoid annoying reflections for the operators or, in the case of dental lamps and in some surgical applications, in order to avoid directly illuminating the patient's eyes that are very close to the operating field.

The illumination area, also called “spot” or “light spot”, has characteristics defined depending on the application. For example, there may be a first region of greater luminous intensity and a second surrounding region of lower luminous intensity. The illumination area or the regions that compose it are typically illuminated in a relatively uniform manner.

The boundary between the directly illuminated illumination area and the not directly illuminated surrounding environment is preferably sharp, so as to reduce as much as possible the direct illumination of the surrounding environment.

A typical example of an operating lamp is the dental lamp.

Dental lamps are able to illuminate the patient's oral cavity with a luminous intensity that typically exceeds 25000 lux, can reach and sometimes exceed 70,000 lux, and which is focused in a beam that, from a distance of about 70 centimetres, illuminates the oral cavity of a patient. The requirements of the dental lamps are indicated in the ISO UNI EN 9680 standard.

Surgical lamps are capable of generating a luminous intensity that typically exceeds 40000 lux and can reach up to 200000 lux from a distance of one metre. Compared to the dental lamps, surgical lamps have a typically greater field depth and can illuminate a larger area.

For easy handling, the operating lamps are mounted on an articulated arm that enables the operator to modify the position and the spatial orientation of the lamp.

Some types of dental lamps use two light sources mounted on a lamp body and configured to emit respective light beams and two reflectors integrated into the lamp body to reflect the light beams by focusing them along respective luminous axes.

A reflector of the above-mentioned type comprises a multitude of reflecting surfaces configured to reflect the light coming from the luminous source so as to obtain the light beam and to focus it on the illumination area with the desired characteristics. Each reflecting surface is positioned and oriented so as to reflect a pre-set amount of light emitted by the light source towards a pre-set point on the illumination area.

### SUMMARY

The Applicant has found that an error in positioning the reflecting surfaces, even relatively small, leads to a significant alteration of the characteristics of the illumination area.

The Applicant has found that in order to obtain the desired illumination characteristics in the illumination area, the reflector must be made with strict dimensional tolerances, so that the reflecting surfaces are positioned and oriented correctly. In the case of the dental and surgical field, in order to obtain an illumination area with the desired characteristics, the reflector must be made and positioned with a surface tolerance of less than 300 μm The Applicant has verified that integrating the light source and the reflector in the lamp body risks introducing errors in the position and/or orientation of the reflecting surfaces with respect to the light sources, consequently affecting the characteristics of the light beam and the illumination area.

The Applicant has found that, in order to position each reflector with adequate precision with respect to the light source thereof, the lamp body should be made with a dimensional precision of the same order of magnitude as the reflector. However, this measure involves adopting high-precision production technologies in the production of the lamp body, with costs that increase with the number of reflectors.

The Applicant has found that, if it the arrangement of the reflector with respect to the lamp body could be adjusted on a relatively small scale, possible errors in the positioning of the reflector with respect to the light source, for example due to the dimensional tolerances of the lamp body itself, could be compensated. This would allow the lamp body to be made with standard type technologies and would lead to considerable cost reduction.

The present invention therefore concerns an operating lamp, comprising:
a lamp body;
at least one luminous source mounted on the lamp body;
at least one reflector configured to reflect a light beam emitted by said at least one luminous source and to focus said light beam along a luminous axis;
a plurality of mounting members spaced apart from each other and mounted on said lamp body, each mounting member comprising a respective end stop shoulder having an independently adjustable position relative to said lamp body along an adjustment axis of said mounting member;
at least one support body comprising a plurality of mounting portions, each mounting portion being slidably coupled to a respective mounting member of said plurality of mounting members along the adjustment axis of said respective mounting member, the end stop shoulder of said respective mounting member limiting a sliding of said mounting portion along the respective adjustment axis, wherein each mounting portion is pressed against the end stop shoulder of said respective mounting member by a respective elastic element;
wherein said at least one reflector is mounted on said at least one support body.

The reflector is mounted on the support body. The arrangement of the support body with respect to the lamp body results in the arrangement of the reflector with respect to the luminous source, which is also mounted on the lamp body.

The mounting portions of the support body are slidably coupled to the mounting members so as to be constrained to slide along the respective adjustment axes.

Each mounting portion is pushed against the respective end stop shoulder by a respective elastic element. Adjusting the position of the end stop shoulder allows to adapt the position of each mounting portion along the respective adjustment axis so as to adjust the arrangement of the reflector with respect to the luminous source.

The end stop shoulder stops the mounting portion along the adjustment axis without rigidly locking it. In this way, each mounting portion is non-rigidly mounted on the respective mounting member.

This avoids or limits possible deformations of the support body and the reflector associated with it due to bending or twisting introduced at the mounting portion. The position of the mounting portion along the adjustment axis can thus be precisely adjusted avoiding, or at least limiting, possible deformations of the support body.

By adjusting the position of each mounting portion in this way, possible errors in positioning the reflector and/or the luminous source on the lamp body can be compensated and the desired illumination characteristics can be obtained in the illumination zone, avoiding or limiting alterations due to deformations of the reflector induced by the adjustment.

In the present description and in the united claims, terms such as “elastic”, “elastically” and the like refer to elastic bodies or elements having an elastic constant of less than 10⁵ N/m and configured to undergo deformation as a result of the application of external loads, to exert a variable force depending on the amount of deformation, and to return to the original state after the removal of the external loads.

The terms “axial”, “axially”, “radial”, “radially”, “circumferential” and “circumferentially”, when referred to a mounting member, mounting portion, mounting seat, or elastic element are used with reference to the respective adjustment axis, unless otherwise specified.

In particular, by the terms “axially” and “axially” are meant references/quantities that are arranged/measured or extend in a direction substantially parallel to the respective adjustment axis.

By the terms “radial” and “radially” are meant references/quantities that are arranged/measured or extend in a direction perpendicular to the respective adjustment axis and lying in a plane perpendicular to the respective adjustment axis.

By the terms “circumferential” and “circumferentially” are meant references/quantities that are arranged/measured or extend in an angular direction around the respective adjustment axis and lying in a plane perpendicular to said respective adjustment axis.

The terms “radially inner/outer” respectively refer to a position closer to or farther from the respective adjustment axis.

By the term “reflector” is meant a body provided with a reflecting surface configured to reflect visible light so as to reflect at least 75% of the incident luminous radiation, for example a mirror.

The present invention may comprise at least one of the preferred features described below.

Preferably, said mounting members are spaced apart from each other by at least 3 centimetres.

The distance between the mounting members allows to adjust the inclination of the reflector by differentially adjusting the position of the respective end stop shoulders.

Preferably, said mounting members are spaced apart from each other by a distance comprised between 4 centimetres and 15 centimetres. Preferably, the adjustment axes of the mounting members of each support body are parallel to each other.

Preferably, each mounting member is mounted on said lamp body by a threaded coupling.

Preferably, the position of each end stop shoulder is adjustable by acting on said threaded coupling.

The threaded coupling allows the mounting member to be stably mounted to the lamp body allowing an adjustment of the position of the end stop shoulder by screwing, unscrewing.

Preferably, said threaded coupling comprises a threading extended along said adjustment axis of the respective mounting member.

Preferably, said lamp body comprises a plurality of mounting seats.

Preferably, each mounting member comprises a stem engaged in a mounting seat of said plurality of mounting seats.

Preferably, said threaded coupling is realised between said stem and said mounting seat.

Preferably, said mounting member comprises a screw or a bolt.

Preferably, by acting by screwing on said threaded coupling the respective end stop shoulder is moved closer to the respective mounting seat.

The mounting portion is thus moved closer to the mounting seat as opposed to the elastic element.

Preferably, by unscrewing said threaded coupling, the respective end stop shoulder is moved away from the respective mounting seat.

The mounting portion is thus moved away from the mounting seat pushed by the elastic element against the end stop shoulder.

Preferably, each mounting portion can slide along the adjustment axis between the respective end stop shoulder and the respective mounting seat deforming the respective elastic element.

Preferably, a plurality of elastic elements are provided.

Preferably, to each mounting member of said plurality of mounting members is associated a respective elastic element of said plurality of elastic elements.

Preferably, said respective elastic element is arranged around said mounting member.

In this way, the elastic element acts along the adjustment axis. The stability of the elastic element is also improved.

Preferably, said respective elastic element is arranged around the stem of the mounting member.

Preferably, each elastic element comprises a spring, preferably helical.

Preferably, each elastic element is interposed between a mounting portion and a mounting seat.

Preferably, each mounting seat of said plurality of mounting seats comprises a first abutment surface.

Preferably, each elastic element extends between a first end and a second end.

Preferably, each elastic element is configured to exert an axial elastic force between the first end and the second end.

Preferably, the first end of each elastic element is arranged in abutment against the first abutment surface of the respective mounting seat.

Preferably, each mounting seat comprises a seat hole.

Preferably, each mounting member engages the seat hole of the respective mounting seat.

Preferably, the stem of each mounting member is threaded.

Preferably, the stem of each mounting member is of the self-tapping type.

Preferably, the seat hole of each mounting seat is counter-threaded to the stem of the respective mounting member.

Preferably, the seat hole of each mounting seat is arranged to be engaged by said self-tapping stem to create a counter-threading to said stem.

Preferably, said threaded coupling is realised between said threaded stem and said counter-threaded seat hole.

Preferably, the first abutment surface of each mounting seat surrounds the seat hole of said mounting seat.

Preferably, the first abutment surface extends circumferentially around the adjustment axis.

Preferably, each mounting portion of said plurality of mounting portions comprises a second abutment surface.

Preferably, the second end of each elastic element is arranged in abutment against said second abutment surface of the respective mounting portion.

Preferably, each mounting portion of said plurality of mounting portions comprises a through hole.

Preferably the through hole of each mounting portion is crossed by the respective mounting member.

Preferably, the mounting member is inserted with radial clearance into the through hole of the respective mounting portion.

Each mounting portion of said plurality of mounting portions comprises an end stop surface against which the end stop shoulder of the respective mounting member is arranged in abutment.

Preferably, said end stop surface surrounds said through hole.

Preferably, the end stop surface extends circumferentially around the adjustment axis.

Preferably, said through hole extends from said end stop surface to said second abutment surface.

Preferably, said second abutment surface surrounds said through hole. Preferably, the second abutment surface extends circumferentially around the adjustment axis.

Preferably, each mounting portion of said plurality of mounting portions comprises a housing seat.

Preferably, each elastic element is housed at least partially, preferably completely, within the housing seat of a respective mounting portion. Preferably, each mounting member of said plurality of mounting members comprises a head on which the respective end stop shoulder is defined.

Preferably, said end stop shoulder protrudes radially with respect to said adjustment axis.

Preferably, said head comprises a manoeuvring portion.

Preferably, the mounting portion coupled to the respective mounting member comprises a manoeuvring seat.

Preferably said head is housed in said manoeuvring seat.

Preferably said manoeuvring seat allows access to said manoeuvring portion to adjust the position of said end stop shoulder.

Preferably, each support body is made of a different material with respect to said reflector.

Preferably, each support body is made of plastic material.

Preferably, each support body comprises a concave support seat in which said reflector is placed.

Preferably said support seat has an ovoid shape.

Preferably, each reflector is mounted in the support seat of the respective support body by snap-fitting.

Preferably, said support seat has a counter-shape to a rear surface of said reflector.

Preferably the mounting portions of each support body are distributed around the respective support seat.

Preferably the mounting portions are distributed along a perimeter of said support seat.

Preferably, said support body is made as one piece.

Preferably, the mounting portions are made as one piece with said support seat.

Preferably said perimeter is ovoid.

Preferably, each support body comprises at least three mounting portions.

Preferably, each support body comprises four mounting portions.

Preferably, said four mounting portions are placed at respective corners of a rectangle.

Preferably the mounting portions of each support body are arranged in a common plane.

Preferably, said support seat is concave with respect to said common plane.

Preferably the adjustment axes of the mounting members of each support body are inclined obliquely with respect to the respective common plane of the mounting portions.

Preferably, each reflector comprises a plurality of reflecting surfaces arranged following a substantially parabolic surface.

Preferably, said concave support seat has a shape following said substantially parabolic surface.

Preferably, there is provided a plurality of luminous sources mounted on the lamp body.

Preferably, a plurality of reflectors are provided.

Preferably, each reflector of said plurality of reflectors is configured to reflect a light beam emitted by a respective luminous source of said plurality of luminous sources and to focus said light beam along a respective luminous axis.

Preferably, for each reflector, a plurality of mounting members spaced apart from each other and mounted on said lamp body is provided.

Preferably, each mounting member comprises a respective end stop shoulder.

Preferably, said respective end stop shoulder has an independently adjustable position with respect to the lamp body along an adjustment axis of the mounting member.

Preferably, for each reflector, a respective support body comprising a plurality of mounting portions is provided.

Preferably, each mounting portion is slidably coupled to a respective mounting member of said plurality of mounting members along the adjustment axis of said respective mounting member.

Preferably, the end stop shoulder of said respective mounting member limits a sliding of said mounting portion along the respective adjustment axis.

Preferably, each mounting portion is pressed against the end stop shoulder of the respective mounting member by a respective elastic element.

Preferably, each reflector is mounted on the respective support body. Preferably, the reflectors of said plurality of reflectors are more than two in number.

Preferably, the reflectors of said plurality of reflectors are circularly distributed in said lamp body.

Further characteristics and advantages of the present invention will become clearer from the following detailed description of preferred embodiment thereof, with reference to the appended drawings and provided by way of indicative and non-limiting example, wherein:

### BRIEF DESCRIPTION OF THE DRAWINGS

FIG. 1A shows a perspective view of an operating lamp in accordance with the present invention;

FIG. 1B shows a perspective view from a different angle of the operating lamp of FIG. 1A;

FIG. 2 shows a schematic sectional view of the operating lamp of FIG. 1A;

FIG. 3 shows a partially exploded view of some components of the operating lamp of FIG. 1A;

FIG. 4 shows a sectional view of the operating lamp of FIG. 1A;

FIG. 5 shows a different sectional view of the operating lamp of 1A;

FIG. 6 shows a sectional view of a detail of the operating lamp of FIG. 1A;

FIG. 7 shows a perspective view of components of the operating lamp of FIG. 1A;

FIG. 7A shows a perspective view of a component of the operating lamp of FIG. 1A;

FIG. 7B shows a different perspective view of a component of the operating lamp of FIG. 1A.

### DETAILED DESCRIPTION

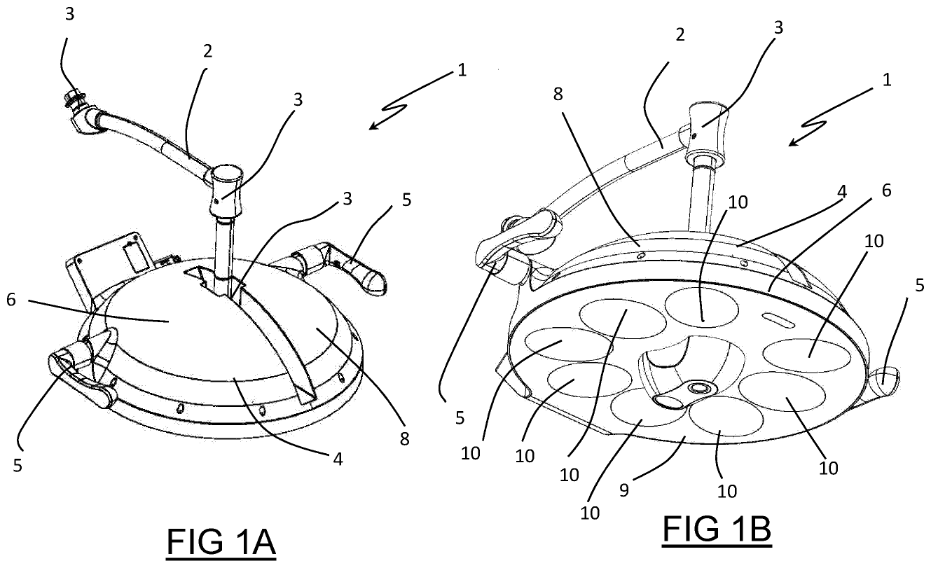

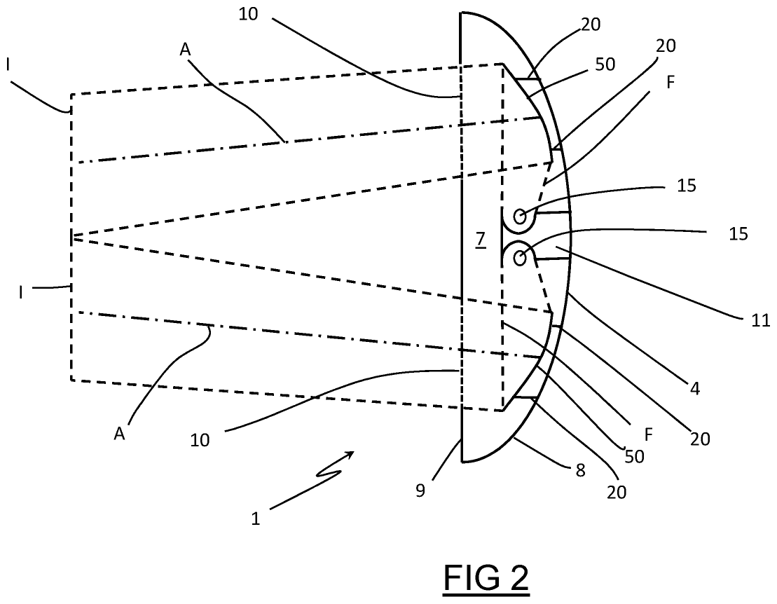

An operating lamp in accordance with the present invention is illustrated in FIGS. 1A and 1B, wherein it is indicated as a whole with reference numeral 1.

The lamp 1 comprises an arm 2 provided with a plurality of joints 3. A lamp body 4 is connected to the arm 2, preferably at its centre of gravity. The lamp body 4 comprises two handles 5 that can be gripped by an operator to move the lamp body 4 by acting on the joints 3 of the arm 2.

The lamp body 4 comprises a casing 6 inside which there is defined a containment volume 7. The casing 6 comprises a dome 8 having a concavity defining the containment volume 7. The casing 6 further comprises a disc 9 fixed to the dome 8 and delimiting together with the dome 8 the containment volume 7. On the casing 6, and in particular on the disc 9, a plurality of illumination windows 10 are defined, preferably of substantially circular or oval shape, configured to let respective light beams exit from the containment volume 7. The illumination windows 10 are distributed circumferentially on the disc 9. In the illustrated embodiment, the illumination windows 10 are eight in number.

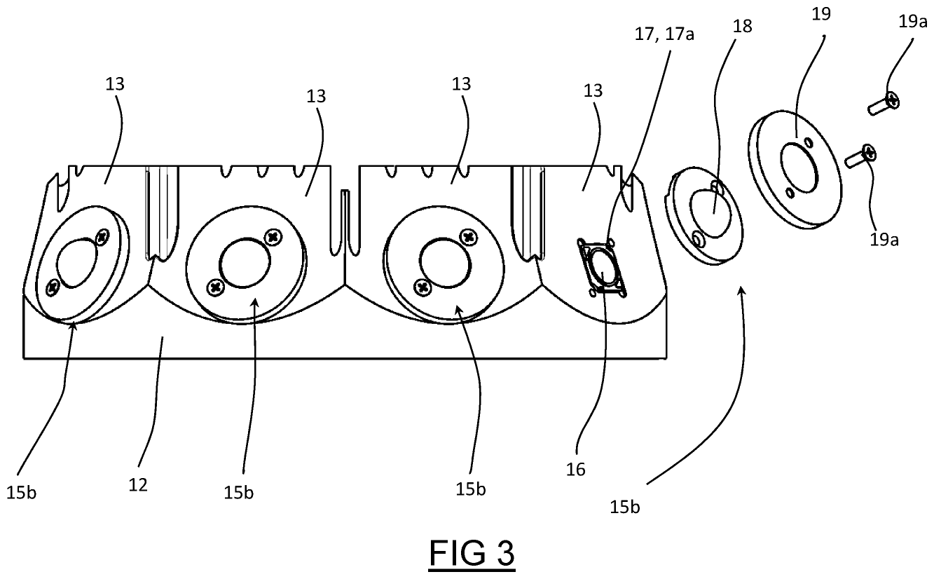

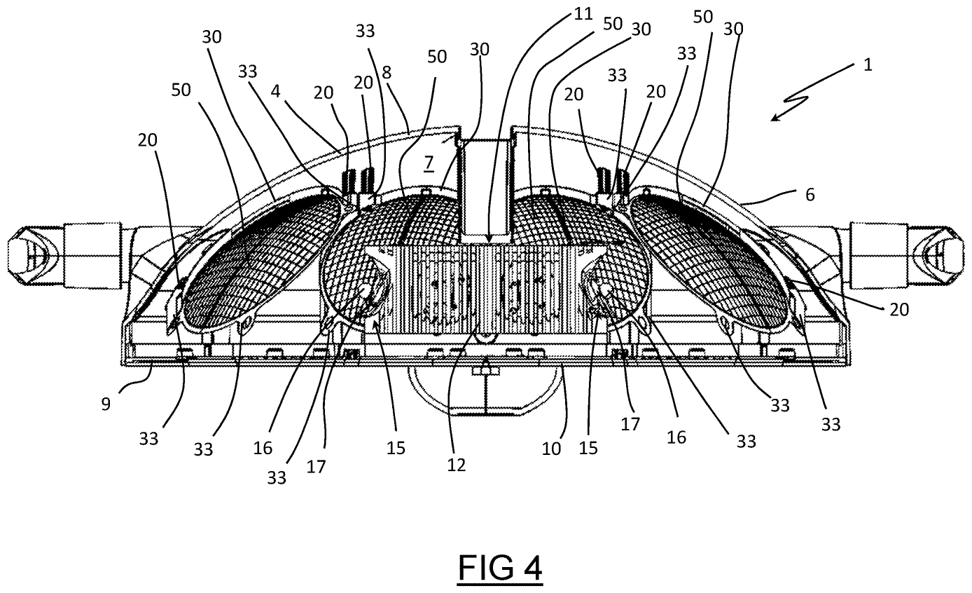

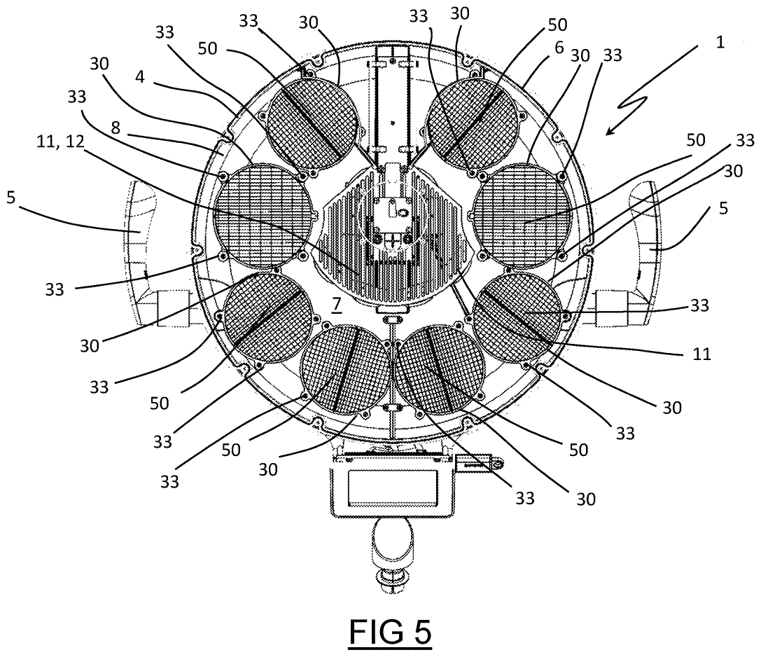

The lamp body 4 comprises a central assembly 11 placed in the containment volume 7, illustrated in detail in FIG. 3 and in section inside the lamp body 4 in FIGS. 4 and 5. The central assembly 11 is arranged substantially in the centre of the containment volume 7, preferably at the centre of gravity of the lamp 1. The central assembly 1 comprises one or more heat sinks 12.

At least one luminous source 15 is mounted on the lamp body 4, integral with the lamp body 4. In the illustrated embodiment there are eight luminous sources 15.

Each luminous source 15 is mounted on the central assembly 11.

The luminous sources 15 are placed around the central assembly 11 and are turned radially outwards with respect to the central assembly 11. Each luminous source 15 is mounted on the heat sink 12 and in particular in a respective recessed seat 13.

Each luminous source 15 comprises an LED (light emitting diode) 16 and an electronic control module 17. The LEDs 16 of the illustrated embodiment are of the SMD (surface mounted device) type and are mounted on a printed circuit 17a that integrates the control module 17. In embodiments not illustrated, the LEDs 16 and the printed circuit 17a could be part of a COB (Chip on board) device that integrates the control module 17. A lens 18 is mounted on each luminous source 15. A mounting collar 19 is placed on each luminous source 15 and on the respective lens 18 for mounting on the heat sink 12. Mounting members 19a, e.g. screws, tighten the mounting collar 19 against the heat sink 12, with the respective lens 18 and the respective luminous source 15 interposed between the heat sink 12 and the respective mounting collar.

The heat sink 12 is configured to dissipate the heat operatively generated by the electronic control modules 17 and the LEDs 16. Each luminous source 15 is configured to operatively emit a respective light beam F.

The luminous sources 15 are configured to emit the respective light beams F radially outwards with respect to the central assembly 11.

For each luminous source 15, the lamp body 4 comprises a respective reflector 50.

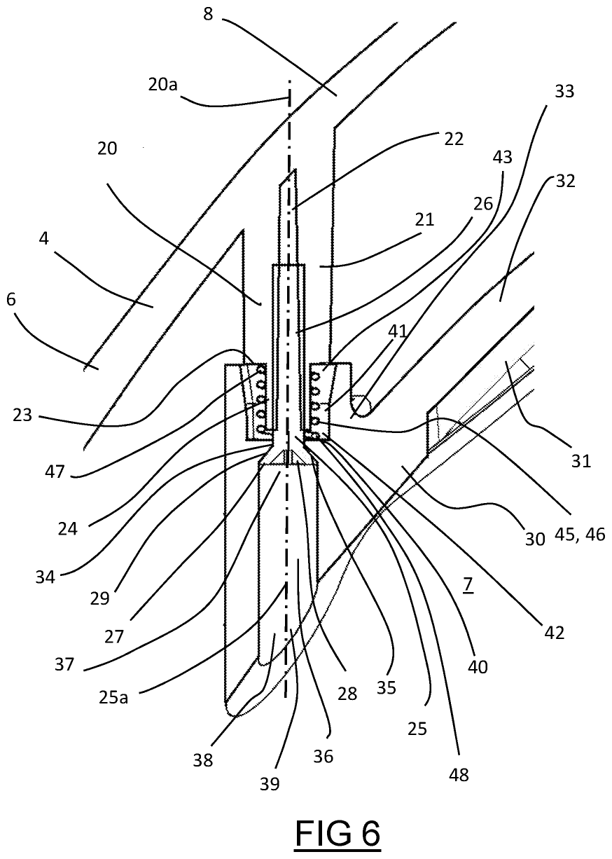

For each luminous source 15 (and thus for each respective reflector 50), the lamp body 4 comprises a plurality of mounting seats 20 for mounting the respective reflector 50. In the illustrated embodiment, the lamp body 4 comprises four mounting seats 20 for each reflector 50. The mounting seats 20 are placed on the dome 8. A mounting seat 20 is illustrated in detail in FIG. 6.

Each mounting seat 20 comprises a protrusion 21 protruding towards the containment volume 7 along a mounting seat axis 20a, as illustrated in FIG. 6. The protrusion 21 is made as one piece with the dome 8. Each mounting seat 20 comprises a seat hole 22. The seat hole 22 is defined inside the protrusion 21. The seat hole 22 develops along the mounting seat axis 20a. The seat hole 22 can be threaded internally or be arranged to be threaded by a self-tapping stem, as will be clear from the continuation of the present description.

Each mounting seat 20 further comprises a first abutment surface 23. The first abutment surface 23 is orthogonal to the mounting seat axis 20a. The first abutment surface 23 is defined on the protrusion 21, turned towards the containment volume 7. The first abutment surface 23 circumscribes the seat hole 22.

Each mounting seat 20 further comprises an end stop wall 24, which protrudes from the first abutment surface 23 along the mounting seat axis 20a around the seat hole 22.

For each luminous source 15 (and thus for each respective reflector 50), the lamp 1 comprises a plurality of mounting members 25. In particular, for each mounting seat 20, the lamp 1 comprises a respective mounting member 25. An example of mounting member 25 is illustrated in FIG. 6. In the illustrated embodiment, the lamp 1 comprises four mounting members 25 for each luminous source 15.

Each mounting member 25 engages a respective mounting seat 20. Each mounting member 25 comprises a threaded stem 26 and a head 27. The head 27 has a larger diameter than the stem 26. The head 27 comprises a manoeuvring portion 28, for example a shaped coupling for a screwdriver or an Allen key. In the illustrated embodiment each mounting member 25 is a threaded member, in particular a bolt.

The stem 26 is placed in threaded engagement with the seat hole 22 of the respective mounting seat 20. The stem 26 may be of the self-tapping type and configured to create a respective counter-threading internally to the respective seat hole 22. The position of the mounting member 25 with respect to the mounting seat 20 is adjustable along an adjustment axis 25a. The adjustment axis 25a is aligned with the mounting seat axis 20a. The position of the mounting member 25 with respect to the mounting seat 20 is adjustable by rotating the mounting member 25 so as to screw or unscrew the stem 26 in the seat hole 22. The adjustment can be carried out by an operator by acting on the manoeuvring portion 28, for example by means of a tool such as a screwdriver or an Allen key.

Each mounting member 25 comprises an end stop shoulder 29 turned towards the respective mounting seat 20. The end stop shoulder 29 is defined on the head 27. The end stop shoulder 29 develops circumferentially around the adjustment axis 25a. The end stop shoulder 29 protrudes radially from the stem 26. In the illustrated embodiment, the shoulder 29 has a frusto-conical shape.

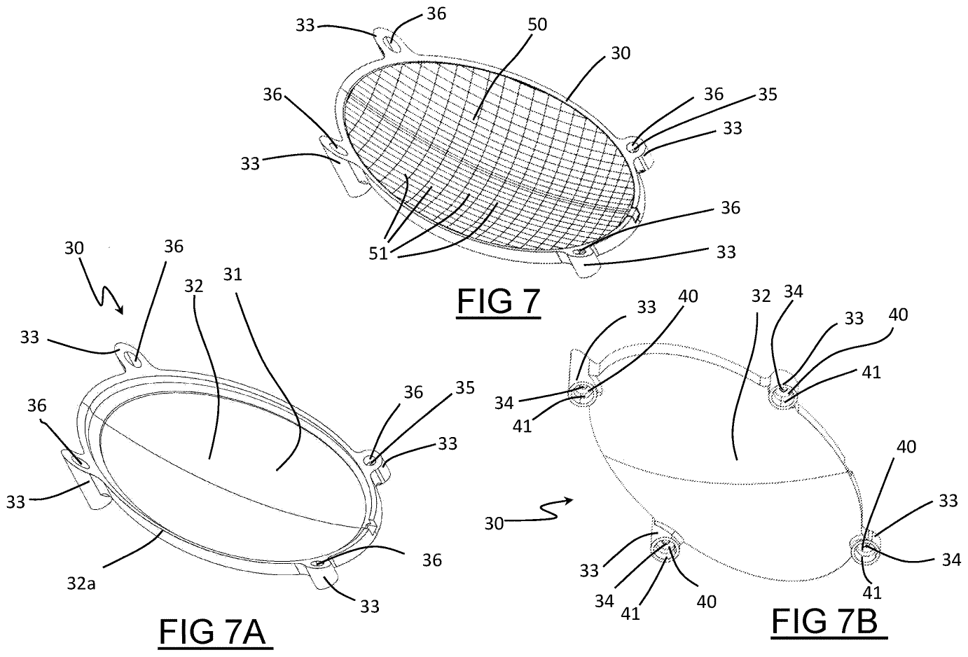

For each luminous source 15 (and thus for each respective reflector 50), the lamp 1 comprises a support body 30. In the illustrated embodiment, the lamp 1 comprises eight support bodies 30. An example of support body 30 is illustrated in FIGS. 7, 7A and 7B. Preferably, each support body 30 is made as a single piece.

Each support body 30 comprises a support seat 31. The support seat 31 has an ovoid plan shape and has a concavity turned towards the respective luminous source 15.

The support seat 31 is defined by a concave support wall 32 having substantially constant thickness. The support seat 31 is turned towards a respective illumination window 10. The support seat 31 is surrounded by a perimeter edge 32a.

Each support body 30 comprises a plurality of mounting portions 33. Each support body 30 comprises a mounting portion 33 for each mounting seat 20. In the illustrated embodiment each support body 30 comprises four mounting portions 33. The mounting portions 33 are arranged around the support seat 31. The mounting portions 33 are arranged at the four vertices of a rectangle. The mounting portions 33 of each support body lie in a common plane obliquely crossed by the respective adjustment axes 25a.

Each mounting portion 33 comprises a through hole 34. The through hole 34 is crossed by a respective mounting member 25, in particular by the respective stem 26. The through hole 34 has a smaller diameter than the head 27 of the mounting member 25.

The mounting member 25 is mounted fixed with respect to the mounting seat 20, and the mounting portion 33 can slide with respect to the mounting member 25 along the adjustment axis 25a.

Each mounting portion 33 comprises an end stop surface 35 turned towards the opposite side with respect to the mounting seat 20. The end stop surface 35 is defined around the through hole 34. The end stop surface 35 is configured to come into abutment against the end stop shoulder 29 of the respective mounting member 25 to limit a sliding of the mounting portion 33 along the adjustment axis 25a. The end stop surface 35 is preferably counter-shaped to the end stop shoulder 29. In particular, the end stop surface 35 is frusto-conical.

Each mounting portion 33 comprises a manoeuvring seat 36 inside which the head 27 is housed. The manoeuvring seat 36 is a recess defined in the mounting portion 33 turned towards the opposite side with respect to the mounting seat 20. The manoeuvring seat 36 extends along the adjustment axis 25a from a first end 37 at which there are defined the through hole 34 and the end stop surface 35 to an opposite second end 38 at which the manoeuvring seat 26 comprises an opening 39 configured to allow an operator to access the manoeuvring portion 28 with a tool. The manoeuvring seat 36 has a larger diameter than the through hole 34.

Each mounting portion 33 comprises a second abutment surface 40 turned towards the mounting seat 20. The second abutment surface 40 faces the first abutment surface 23. The second abutment surface 40 is defined around the through hole 34. The second abutment surface 40 is orthogonal to the adjustment axis 25a. In the illustrated embodiment, the second abutment surface 40 is annular.

The second abutment surface 40 is placed on the opposite side to the end stop surface 35 with respect to the through hole 34. The through hole 34 extends from the second abutment surface 40 to the end stop surface 35.

Each mounting portion 33 comprises a housing seat 41. The housing seat 41 is a recess defined in the mounting portion 33 turned towards the mounting seat 20. The housing seat 41 is opposite to the manoeuvring seat 36 with respect to the through hole 34.

The housing seat 41 extends along the adjustment axis 25a from a first end 42 at which there are defined the through hole 34 and the second abutment surface 40 to an opposite second end 43 at which the housing seat 41 is open towards the mounting seat 20.

For each luminous source 15 (and thus for each respective reflector 50), the lamp body 4 comprises a plurality of elastic elements 45. In particular, the lamp 1 comprises an elastic element 45 for each mounting seat 20. In the illustrated embodiment, the lamp body 4 comprises four elastic elements 45 for each luminous source 15. Each elastic element 45 is arranged around a respective mounting member 25. In the illustrated embodiment, each elastic element 45 comprises a helical-type spring 46. The spring 46 is wound around the stem 26 of the respective mounting member 25. The spring 46 is also at least partially wound around the end stop wall 24.

Each elastic element 45 is interposed between a respective mounting seat 20 and a respective mounting portion 33. Each elastic element 45 comprises a first end 47 placed in abutment against the first abutment surface 23 and a second end placed in abutment against the second abutment surface 40.

Each elastic element 45 is compressed between the first end 47 and the second end 48 so as to exert an elastic force against the respective mounting portion 33 away from the respective mounting seat 20.

The elastic force exerted by each elastic element 45 pushes the end stop surface 35 of the respective mounting portion 33 into abutment against the end stop shoulder 29 of the respective mounting member 25.

In the illustrated embodiment the lamp 1 comprises eight reflectors 50. An example of reflector 50 is illustrated in FIG. 7. Each reflector 50 is mounted on a respective support body 30, in the respective support seat 31. The support seat 31 is counter-shaped to a rear surface of the reflector 50.

Each reflector 50 is substantially parabolic in shape. The reflector 50 is inserted interlockingly in the support seat 31. The reflector 50 has a rear surface, not shown, placed as resting against the support wall 32. The reflector 50 is placed flush with the perimeter edge 32a. An adhesive, for example of the silicone type, can be applied between the reflector 50 and the support body 30 for mutual fixing.

Each reflector 50 comprises a plurality of planar reflecting surfaces 51, arranged following a substantially parabolic surface. In the illustrated embodiment, the reflecting surfaces 51 are substantially rectangular in shape.

Each reflector 50 is configured to reflect a respective light beam F coming from the respective luminous source 15 along a luminous axis A so as to focus it along the luminous axis A, in an illumination zone I with predetermined characteristics. In particular, each reflecting surface 51 is arranged so as to reflect an amount of light emitted by the luminous source 15 onto the illumination zone I in a predetermined manner.

Tin order to obtain the desired illumination characteristics in the illumination zone I, compensating for possible positional errors of the reflectors 50 with respect to the respective luminous sources 15, given for example by the dimensional and/or reciprocal positioning tolerances of the lamp body 4 and of the heat sink 12, the arrangement of the reflectors 50 is adjusted by adjusting the position of each end stop shoulder 29 by acting on the respective mounting member 25. In this way, the position along the adjustment axis 25a of each mounting portion 33 is adjusted. Differentially adjusting the positions of the end stop shoulders 29 adjusts the inclination of the support body 30, and thus of the reflector 50 mounted thereon, with respect to the lamp body 4 and the luminous source 15. Uniformly adjusting the positions of the end stop shoulders 29 adjusts the position of the support body 30, and thus of the reflector 50 mounted thereon, with respect to the lamp body 4 and the luminous source 15.

The present invention has been described with reference to some preferred embodiments thereof. Various modifications can be made to the embodiments described above, still remaining within the scope of protection of the invention, defined by the following claims.

1. An operating lamp, comprising:
a lamp body;
at least one luminous source mounted on the lamp body;
at least one reflector configured to reflect a light beam emitted by said at least one luminous source and to focus said light beam along a luminous axis;
a plurality of mounting members spaced apart from each other and mounted on said lamp body, each mounting member comprising a respective end stop shoulder having an independently adjustable position relative to said lamp body along an adjustment axis of said mounting member;
at least one support body comprising a plurality of mounting portions, each mounting portion being slidably coupled to a respective mounting member of said plurality of mounting members along the adjustment axis of said respective mounting member, the end stop shoulder of said respective mounting member limiting a sliding of said mounting portion along the respective adjustment axis, wherein each mounting portion is pressed against the end stop shoulder of said respective mounting member by a respective elastic element;
wherein said at least one reflector is mounted on said at least one support body.

2. The operating lamp according to claim 1, wherein each mounting member of the plurality of mounting members is mounted on said lamp body by a threaded coupling, the independently adjustable position of each end stop shoulder being adjustable by acting on said threaded coupling.

3. The operating lamp according to claim 2, wherein said lamp body comprises a plurality of mounting seats, and wherein each mounting member of the plurality of mounting members comprises a stem engaged in a respective mounting seat of said plurality of mounting seats, said threaded coupling being realised between said stem and said mounting seat.

4. The operating lamp according to claim 3, further comprising a plurality of elastic elements, wherein to each mounting member of said plurality of mounting members is associated a respective elastic element of said plurality of elastic elements

5. The operating lamp according to claim 4, wherein said respective elastic element is arranged around the stem of the respective mounting member.

6. The operating lamp according to claim 5, wherein each mounting seat of said plurality of mounting seats comprises a first abutment surface, and wherein the elastic element associated with the respective mounting member comprises a first end arranged in abutment against said first abutment surface.

7. The operating lamp according to claim 6, wherein each mounting portion of said plurality of mounting portions comprises a second abutment surface, and wherein the elastic member associated with the respective mounting member comprises a second end arranged in abutment against said second abutment surface.

8. The operating lamp according to claim 7, wherein each mounting portion of said plurality of mounting portions comprises a housing seat within which said respective elastic element is housed at least partially, preferably completely.

9. The operating lamp according to claim 1, wherein each mounting member of said plurality of mounting members comprises a head on which the respective end stop shoulder is defined.

10. The operating lamp according to claim 9, wherein said head comprises a manoeuvring portion and wherein said mounting portion coupled to the respective mounting member comprises a manoeuvring seat within which said head is housed, said manoeuvring seat allowing access to said manoeuvring portion to an operator to adjust the independently adjustable position of said end stop shoulder.

11. The operating lamp according to claim 4, wherein each elastic element of said plurality of elastic elements comprises a spring.

12. The operating lamp according to claim 1 wherein said at least one support body comprises a concave support seat wherein said reflector is placed, the plurality of mounting portions being distributed around said support seat.

13. The operating lamp according to claim 12, wherein said reflector comprises a plurality of reflecting surfaces arranged along a parabolic surface, and wherein said support seat having has a concave shape which follows said parabolic surface.

14. The operating lamp according to claim 1, comprising:
a plurality of luminous sources mounted on the lamp body;
a plurality of reflectors, each reflector of the plurality of reflectors being configured to reflect a light beam emitted by a respective luminous source of said plurality of luminous sources and to focus said light beam along a respective luminous axis;
for each reflector of said plurality of reflectors, respective mounting members from the plurality of mounting members are spaced apart from each other and mounted on said lamp body, each of said respective mounting members comprising a respective end stop shoulder, having an independently adjustable position relative to the lamp body along the adjustment axis of each of the respective mounting members;
for each reflector of said plurality of reflectors, a respective support body of the at least one support body is provided comprising respective mounting portions from the plurality of mounting portions each of the respective mounting portions being slidably coupled to a respective mounting member of said plurality of mounting members along the adjustment axis of said respective mounting member, the end stop shoulder of said respective mounting member limiting a sliding of said mounting portion along the respective adjustment axis, wherein each mounting portion is pressed against the end stop shoulder of the respective mounting member by a respective elastic element;
wherein each reflector of said plurality of reflectors is mounted on the respective support body.

15. The operating lamp according to claim 14, wherein the reflectors of said plurality of reflectors are more than two in number and circularly distributed in said lamp body.
